(19) United States
(12) Patent Application Publication
(10) Pub. No.: US 2011/0196724 A1
(43) Pub. Date: Aug. 11, 2011

(54) CONSUMER-ORIENTED COMMERCE FACILITATION SERVICES, APPLICATIONS, AND DEVICES

(76) Inventors: Charles Stanley Fenton, Ypsilanti, MI (US); Pamela J. Taylor, Flower Mound, TX (US); Cory D. Wiegert, Dublin, OH (US)

(21) Appl. No.: 12/702,528

(22) Filed: Feb. 9, 2010

(51) Int. Cl. G06Q 30/00; G06Q 99/00; G06Q 40/00

(52) U.S. Cl. 705/14.16; 705/14.56; 705/14.23; 705/319; 705/42; 705/26.7

(57) ABSTRACT

A consumer-oriented commerce facilitation (COCF) server provides a service that enables a provider to establish a provider profile and enables a consumer to establish a consumer profile. The service accesses a provider profile database and a consumer profile and provides a COCF client application that enables the consumer to maintain: preferred provider information, consumer list information indicating products associated with the consumer, payment account information indicating sources of payment for a purchase transaction, and community information identifying members of a consumer community members. The application enables a consumer to access a preferred provider user interface (UI) that provides links to storefront UIs. The UI enables the consumer to browse and purchase products offered by the provider. The application also enables a consumer to share selectable portions of the consumer profile with selected preferred providers and share a selectable portion of the consumer profile with a consumer selected subset of the consumer community.

### BACKGROUND

1. Field of the Disclosure

The present disclosure relates to electronic or online commerce and, more particularly, electronic commerce applications targeting consumers.

2. Description of the Related Art

As online commerce has flourished with the acceptance and pervasiveness of the Internet and cheaper, smaller, and more powerful access devices and technologies, providers of all sizes have implemented web servers and web pages to establish an online presence. Currently, a consumer's ability to perform online transactions and other related activities with a particular provider as well as the manner in which transactions and other activities may be performed are dictated by the web presence that the provider implements. This provider-centric paradigm may be characterized as one in which the provider is analogous to the hub of a wheel and each consumer represents one of many peripheral entities or spokes. Extending this analogy, a consumer who interacts with multiple providers represents one of the spokes in each of a multitude of hub and spoke environments.

### BRIEF DESCRIPTION OF THE DRAWINGS

FIG. 1 is a block diagram of selected elements of an embodiment of a network implementing a consumer oriented commerce facilitation (“MyMall”) service;

FIG. 2 is a block diagram of selected elements of an embodiment of a network implementing a MyMall service emphasizing the relationship between a provider and a MyMall server;

FIG. 3 is a block diagram of selected elements of an embodiment of a network implementing a consumer-oriented commerce facilitation service emphasizing hardware elements and network implementation;

FIG. 4 is a block diagram of selected elements of an embodiment of a mobile electronic device suitable for use as a user device in connection with the consumer-oriented commerce facilitation service;

FIG. 5 is a block diagram of selected elements of an embodiment of a fixed access device such as a desktop, laptop, or server computer, suitable for use in connection with the consumer-oriented commerce facilitation service;

FIG. 6A is a flow diagram of selected elements of an embodiment of a method of implementing a consumer-oriented commerce facilitation service emphasizing server-side elements;

FIG. 6B is a flow diagram of selected elements of an embodiment of a method of implementing a consumer-oriented commerce facilitation service emphasizing client-side elements;

FIG. 7A is a depiction of an exemplary main menu user interface for a fixed access device;

FIG. 7B is a depiction of an exemplary main menu user interface for a mobile electronic device;

FIG. 8A is a depiction of an exemplary MyStores user interface;

FIG. 8B is a depiction of an exemplary user interface for an electronic storefront;

FIG. 8C is a depiction of an exemplary user interface for an electronic storefront;

FIG. 8D is a depiction of an exemplary user interface for an electronic storefront;

FIG. 9A is a depiction of an exemplary MyLists user interface;

FIG. 9B is a depiction of an exemplary AddItem user interface;

FIG. 10 is a depiction of an exemplary MyCoupons user interface;

FIG. 11A is a depiction of an exemplary MyWallet user interface;

FIG. 11B is a depiction of an exemplary PaymentReceipt user interface;

FIG. 11C is a depiction of an exemplary ShippingTimeline user interface;

FIG. 11D is a depiction of an exemplary ShippingStatus user interface;

FIG. 12A is a depiction of an exemplary MyCommunity user interface;

FIG. 12B is a depiction of an exemplary MyCommunity user interface;

FIG. 12C is a depiction of an exemplary Import user interface;

FIG. 12D is a depiction of an exemplary GlobalSharing user interface;

FIG. 12E is a depiction of an exemplary Sharing user interface;

FIG. 13A is a depiction of an exemplary FindThings user interface;

FIG. 13B is a depiction of an exemplary SearchResults user interface;

FIG. 14 is a depiction of an exemplary TrendSpotter user interface;

FIG. 15 is a depiction of an exemplary Hot-or-Not user interface;

FIG. 16A is a depiction of an exemplary ItemLocator user interface; and

FIG. 16B is a depiction of an exemplary StoreMap user interface.

### DESCRIPTION OF THE EMBODIMENT(S)

Disclosed systems, methods, and models are applicable to a variety of transaction models in which one party buys or otherwise acquires goods or services supplied by another party. Consumers purchase goods from retailers, retailers purchase goods from wholesalers, wholesalers purchase goods from manufacturers, and so forth. In this disclosure, “consumer” is intended to encompass the party purchasing or acquiring goods or services and “provider” is intended to encompass the party selling or otherwise supplying goods or services. Similarly, although the embodiments depicted and described below emphasize a consumer-retailer transaction model, the disclosed subject matter is applicable to other transactions models.

A gap exists between the expectations of providers and consumers with respect to electronic commerce, online transactions, and so forth. Whereas providers expect a standardized experience, mass marketing, mass customization, and channel-oriented operations in which providers dictate terms of the relationship and set the value of goods and services, consumers increasingly expect, in addition to convenience and value, targeted marketing, personalized customization, and a seamless and channel-independent experience in which the consumers dictate the terms of the relationship and set the value of goods and services.

Providers tend to favor a mass-production, mass-customization business model. Consumers are dependent on technology in their everyday personal lives and expect such access to extend to the retail environment. Consumers increasingly expect a custom-made retail offering with something “exclusively” tailored to their needs, from the start.

Disclosed herein is a consumer-oriented commerce facilitation (COCF) server that provides a COCF service, referred to herein as the MyMall service, that enables a MyMall enlisted provider to establish a provider profile and enables a MyMall enlisted consumer to establish a consumer profile. The service accesses a provider profile database and a consumer profile and provides a MyMall client application that enables the consumer to maintain preferred provider information, consumer list information indicating products associated with the consumer, payment account information indicating sources of payment for a purchase transaction, and community information identifying members of a consumer community. The MyMall client application enables a consumer to access a preferred provider user interface (UI) that provides links to storefront UIs. The UI enables the consumer to browse and purchase products offered by the provider. The application also enables a consumer to share a selectable portion of the consumer profile with selected preferred providers and share a selectable portion of the consumer profile with a consumer-selected subset of the consumer community.

Disclosed subject benefits providers by enabling expansion of reach, new channels for impulse creation, and consumer behavior analytics for providers and manufacturers. Consumers benefit through consumer customization and convenience in a single location. Disclosed systems and methods uniquely combine a consumer's social and commercial communities for a seamless experience any place, any time, using any device. In other words, MyMall offers an integration of consumer-oriented services to existing provider systems, expansion of reach, new channels for impulse creation, and consumer behavior analytics for providers.

In the following description, details are set forth by way of example to facilitate discussion of the disclosed subject matter. It should be apparent to a person of ordinary skill in the field, however, that the disclosed embodiments are exemplary and not exhaustive of all possible embodiments. Throughout this disclosure, a hyphenated form of a reference numeral refers to a specific instance of an element and the un-hyphenated form of the reference numeral refers to the element generically or collectively. Thus, for example, widget 12-1 refers to an instance of a widget class, which may be referred to collectively as widgets 12 and any one of which may be referred to generically as a widget 12.

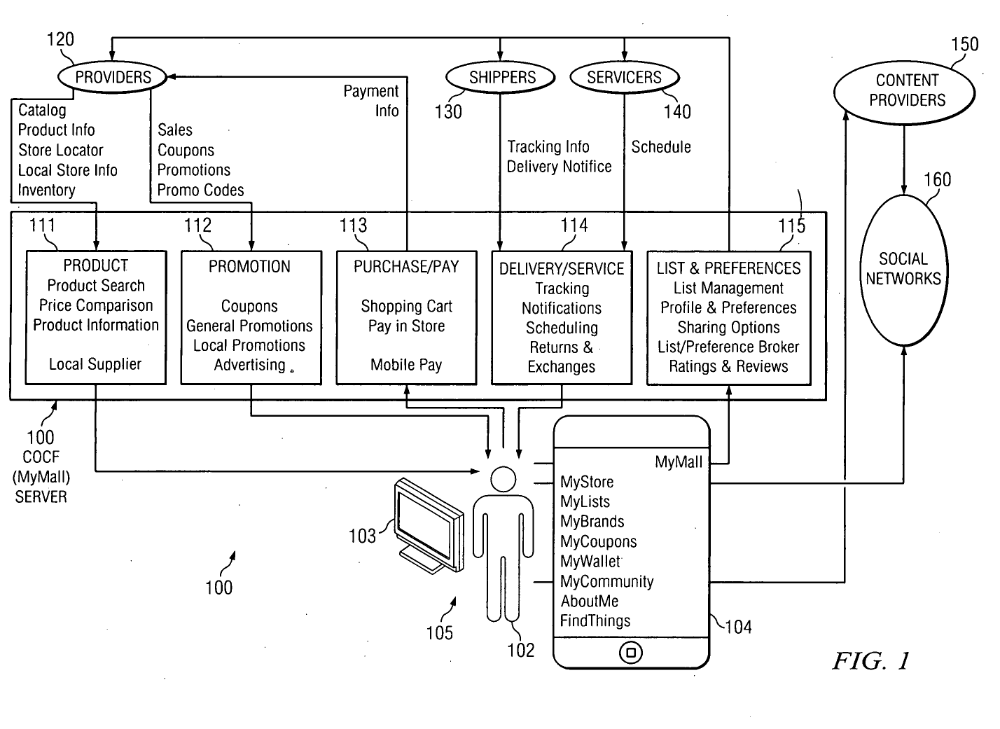

Turning now to the drawings, FIG. 1 is block diagram of selected elements of an embodiment of a network 100 including a MyMall server 110 configured to support a MyMall service described herein for consumers 105 and providers 120. The MyMall service provides consumers with a consumer-centric electronic shopping platform. Using the MyMall service, a consumer may define preferences for stores and brands and interface with preferred stores using a consistent interface. The MyMall service enables consumers to conduct product searches, obtain product information, and compare product prices across multiple providers. In addition, the MyMall service incorporates social networking concepts and links to consumers' existing social networks. The MyMall service leverages social networks to the benefit of consumers and providers by offering providers the opportunity to leverage social network contacts and information of their existing customers and by offering consumers promotions and other incentives for sharing social network information. In addition, consumers benefit by having a tool that enables them to apply social network discourse to consumer transactions, e.g., by enabling promotional notices of products that are popular within a consumer's social network and by facilitating social network surveys and product ratings. The MyMall service provides consumers with a consistent, channel-agnostic shopping experience, integrated with social support systems, that gives consumers greater control to establish value, trust, and personalization.

The MyMall network benefits providers by reducing the time required to deliver customer-centric experience, and by permitting a pay-as-you-play model that optimizes costs and capital investment, by outsourcing the complexity of consumer touch point management. In addition, the channel transparency that the MyMall service employs beneficially encourages providers to focus on driving overall sales. The MyMall service offers providers customer behavior analytics that can be used to optimize decision-making, inventory management, and product placement. The MyMall service facilitates impulse creation, management of promotional programs, and enhanced customer self-service delivered through consumer-owned devices. In addition, the MyMall service also enables forward demand signals, targeted impulse creation, and community-wide analytics.

The depiction of MyMall server 110 in FIG. 1 illustrates consumers 105 and providers 120, as well as shipping companies and services, represented by shippers 130, and service companies represented by servicers 140, interacting with functional modules of MyMall server 110. The functional modules of MyMall server 110 depicted in FIG. 1 include a product module 111, a promotion module 112, a purchase/pay module 113, a delivery/service module 114, and a list and preferences module 115.

Product module 111 as shown in FIG. 1 supports MyMall service features including product searching, price comparison and other product information, and local supplier information. Promotion module 112 as shown supports MyMall service features including electronic coupons, general and local promotional communications, and advertising. Purchase/Pay module 113 includes support for electronic shopping carts, an in-store payment tool, and an online payment tool. Delivery/service module 114 as shown supports package tracking information, shipment notifications, service scheduling information, and shipping logistics for returns and exchanges. List and preferences module 115 is configured to receive or extract list and preference information from consumers and provide the information to providers 120, shippers 130, and servicers 140. List and preferences module 115 may provide consumers with a tool or framework for managing their lists, indicating profile and preference information, information sharing options, a list/preference broker, and a ratings and preferences tool.

As depicted in FIG. 1, MyMall enlisted providers 120 provide information to MyMall server 110 that enable MyMall server 110 to create a MyMall storefront for the provider within a MyMall mall. This information may include catalog information, product information, local store information including store locator information, and local inventory information. In some embodiments, MyMall server 110 enforces information consistency across each of its enlisted providers such that the consumer may be presented with storefronts that have a common set of features and format consistency, which simplifies shopping for the consumer. The storefronts provided may be branded with trademarks and/or other distinguishing indicia, but may otherwise conform to a store-agnostic format.

FIG. 1 further depicts providers 120 delivering promotional and/or impulse creation information to promotion module 112. This information may include sales information, electronic coupon information, and promotion information, including promotion codes. FIG. 1 also depicts providers 120 receiving payment information, provided by consumers 105, from purchase/pay module 113. Shippers 130 are depicted delivering tracking information and shipping notification information to delivery/service module 114 and servicers 140 are depicted providing scheduling information for providing various services including installation services and maintenance and repair services.

The MyMall service depicted in FIG. 1 further incorporates a consumer's social network 160. As depicted in FIG. 1, a consumer may share or otherwise provide consumer-specific MyMall information to social network 160 and/or content providers 150 linked to social networks 160. For example, the MyMall service may enable a consumer to define the scope or extent of the consumer's social network and define lists and/or other information that the consumer wishes to share, either anonymously or otherwise with the defined social network. A consumer might, as an example, share a list of the stores that the consumer includes among his or her preferred stores. List and preferences module 110 may monitor a consumers sharing activity and report the monitored activity to providers 120. Providers 120 might incentivize consumers 105 to share list and preference information with others by offering promotional and/or loyalty rewards.

The consumer 105 as depicted in FIG. 1 includes a person 102 in association with the person's various network access devices. In FIG. 1, the network access devices of consumer 105 include a mobile electronic device 104, represented in FIG. 1 by an iPhone® brand (from Apple, Inc.) or other type of smart phone and a fixed access device 103 represented in FIG. 1 by a desktop or laptop computer. By including a mobile and fixed access device, FIG. 1 emphasizes the accessibility of the MyMall service.

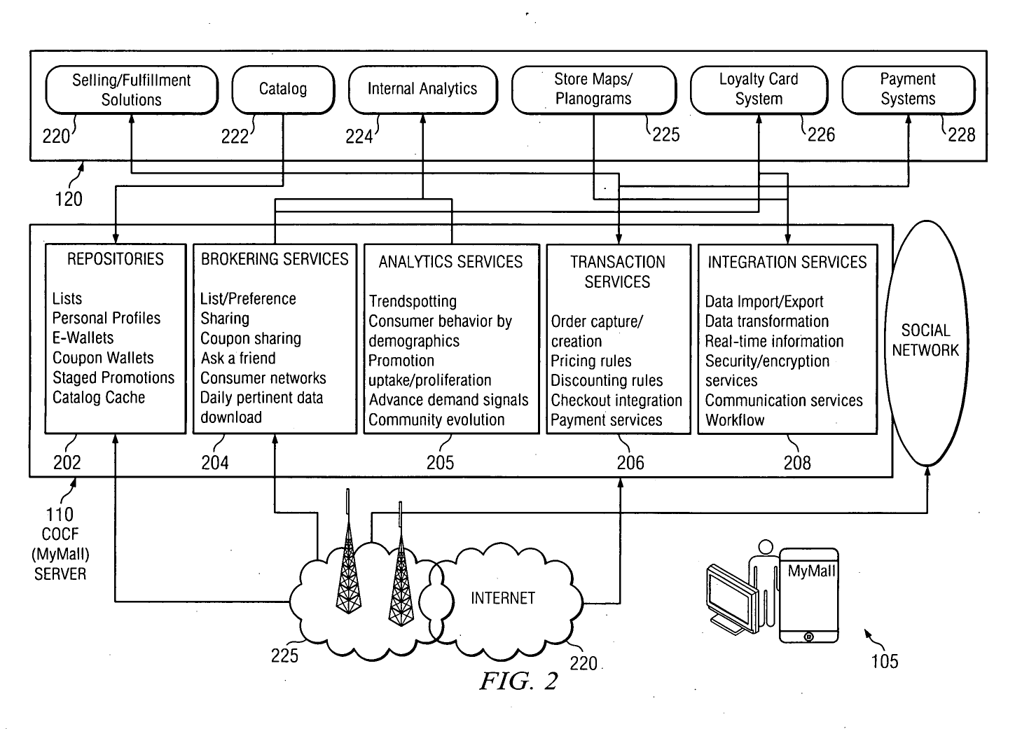

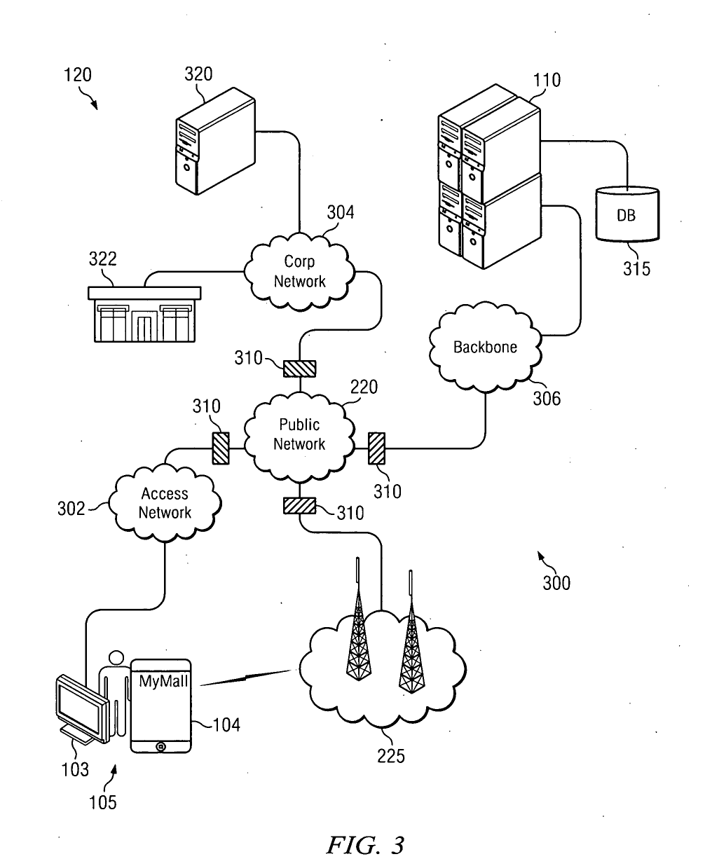

Referring to FIG. 3, selected physical elements of an embodiment of network 100 are depicted to convey an exemplary architectural implementation. In the embodiment depicted in FIG. 3, a provider 120 is represented by a provider server 320 and a provider store 322, e.g., a brick and mortar store. In the depicted implementation, consumer 105, provider 120, and MyMall server 110 are interconnected via the Internet 220 or other form of public or private IP network. Consumer 105, including a user device configured with a MyMall client application, accesses Internet 220 via an access network 302 in the case of a fixed access user device such as fixed access device 103 or via a wireless telephony network 225 in the case of a mobile user device such as mobile electronic device 104. Provider 120, including provider server 320 and provider store 322, access Internet 220 via a corporate network 304. MyMall server 110 is shown as having local or private network access to a MyMall database 315 and connecting to Internet 220.

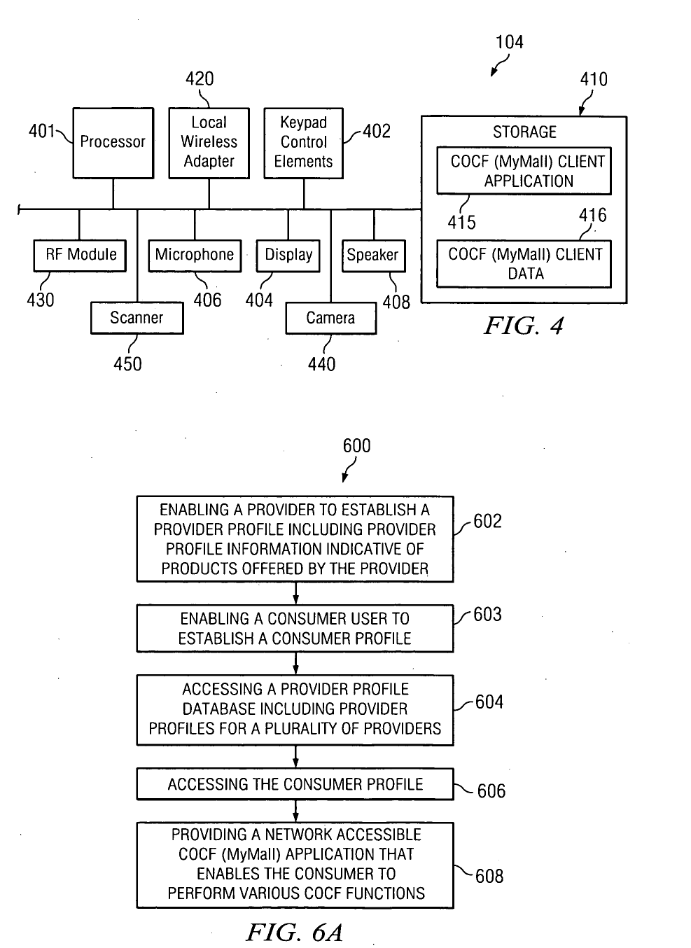

Referring to FIG. 4, selected elements of an embodiment of mobile electronic device 104 are depicted. In the depicted embodiment, mobile electronic device 104 includes a processor 401 having access to tangible computer readable storage media, collectively represented in FIG. 4 as storage 410. Storage 410 may contain or include one or more software applications including an application identified as MyMall client application 415. Storage 410 may further include one or more data structures including a data structure identified as MyMall data 416, which may contain local copies of the consumer's MyMall information including consumer profile, the consumer's list information, preference information, sharing option information, and so forth. MyMall data 416 further include consumer history information.

Mobile electronic device 104 as shown in FIG. 4 further includes peripheral elements that are accessible to processor 401 including a scanner 450, a display 404, and keypad control elements 402, which may be implemented as hardware buttons, soft keys, or the like. Mobile electronic device 104 as shown further includes a microphone 406, a radio frequency (RF) module 430 suitable for establishing cellular communication, a camera 440, a speaker 408, and a local wireless adapter 420 suitable for supporting communication with a wireless data network, e.g., a Bluetooth or WiFi network, that may be confined within a store such as store 322 (FIG. 3) and locations in close proximity to store 322. Mobile electronic device 104 as depicted in FIG. 4 may be characterized by its ability to support cellular communication including voice communication and text message communication as well as wireless data communication including Web communication, email communication, instant messaging communication, and the like. Mobile electronic device 104 may include selected elements of commercially distributed smart phones including, as an example, an iPhone® brand phone from Apple, configured with the aforementioned devices.

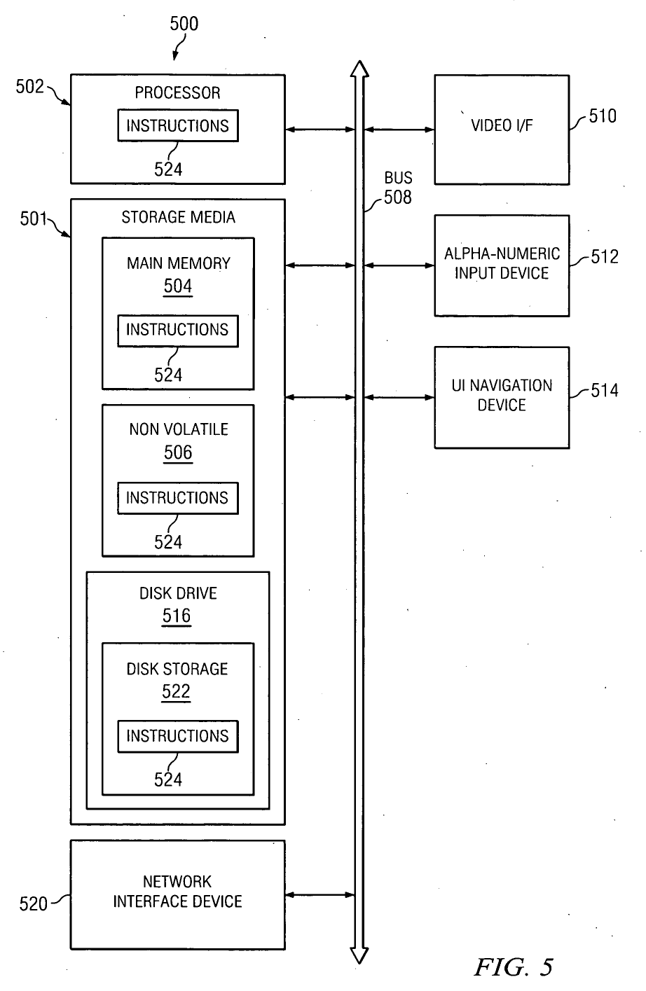

Referring to FIG. 5, selected elements of an embodiment of a fixed access system 500 that may be used to implement servers and/or services disclosed herein (including MyMall server 110 and provider server 320) as well as fixed access user devices such as fixed access device 103 are depicted. The embodiment of system 500 depicted in FIG. 5 includes a processor 502 and machine-readable media 501 that includes a main memory 504, a flash memory or other form of non-volatile memory 506, and a magnetic, semiconductor, or other form of disk storage 522 within a disk drive 516. The components of machine-readable media 501 are accessible to processor 502 via bus 508. The various components of machine-readable media 501 may have stored thereon instructions 524 and data structures (not depicted) embodying or utilized by any one or more of the methodologies or functions of MyMall server 110 described herein. System 500 as depicted further includes a network interface device 520 and various I/O devices including a video interface 510, a keyboard or other form of alphanumeric input device 512, and a mouse or other form of user interface (UI) navigation device 514.

The term “machine-readable media” should be construed as including a single medium or multiple media (e.g., a centralized or distributed database, and/or associated caches and servers) that may store all or part of instructions 524. The term “machine-readable media” shall also be taken to include any tangible medium that is capable of storing or encoding a set of instructions (e.g., instructions 524) for execution by a machine (e.g., system 100) and that cause the machine to perform any one or more of the methodologies or that is capable of storing, encoding, or carrying data structures utilized by or associated with such a set of instructions. The term “machine-readable media” shall, accordingly, be taken to include but not be limited to solid-state memories, optical media, and magnetic media.

Referring now to FIG. 2, elements of an embodiment of network 100 emphasize aspects of the relationship between a provider 120 and MyMall server 110 including aspects of the MyMall service that may motivate a provider to become a MyMall enlisted subscriber and/or a sponsoring provider.

Some embodiments of the MyMall service support multiple types of providers 120 including, in one embodiment, with some providers 120 classified as sponsoring providers and other providers 120 classified as participating providers. As suggested by their names, sponsoring providers may pay a fixed or recurring fee while participating providers may opt merely to have a presence in the MyMall service. Providers may be motivated to become sponsoring providers by offering them access to services and/or information not accessible to participating sponsors. Both types of providers are enlisted MyMall providers that provide all information necessary to enable MyMall server 110 to implement a MyMall-compliant storefront. In exchange for their sponsorship, sponsoring providers may receive information such as a consumer's shared information as well as analytic and/or brokering services supported by MyMall server 110.

As depicted in FIG. 2, provider 120 is represented by exemplary data, applications, and/or modules including selling/fulfillment solutions 220, catalog 222, internal analytics 224, store map/planogram 225, loyalty card systems 226, and payment systems 228. The MyMall server 110 as depicted in FIG. 2 includes modules to support value added features for providers. The modules depicted in FIG. 2 include repositories 202, brokering services 204, analytics service 205, transaction services 206, and integration services 208. Other implementations of MyMall server 110 may include more or fewer modules and/or different modules than the modules depicted in FIG. 2.

Repositories 202 are maintained based upon input from consumers and include consumer lists, personal profiles, electronic wallets, coupon wallets, staged promotions, and cached copies of catalogs provided by providers 120. Brokering services 204 support features that enable providers 120 to leverage social network contacts and information of consumers. Included in this module are features such as list/preference sharing in which a consumer may elect to share a list or preference with one or more providers or one or more members of the consumer's MyMall community and coupon sharing in which a provider may attempt to widen its customer base by permitting or encouraging consumers to distribute coupons or other promotional items to other consumers. Brokering services may further include an ask-a-friend feature in which a consumer solicits a social network contact for information about a service or product, and consumer network associations in which MyMall server 110 may partner with a consumer network to obtain consumer-generated information about its products as well as the products of the provider's competitors. Brokering services 204 may further include features for periodically providing some or all consumer-supplied data to the providers 120, e.g., a daily download of pertinent data.

Analytics services 205 as shown in FIG. 2 may support features such as trend spotting, consumer activity broken down demographically, promotion uptake/proliferation features that track the acceptance and popularity of various promotional approaches, and advance demand signals in which consumers may elect to provide shopping list information to providers and from which providers may make predictive adjustments in inventory levels. For example, a provider 120 may wish to determine which demographic(s) are most likely to share lists and other consumer transaction data with their social networks. Analytics services 205 depicted in FIG. 2 further may include a community evolution feature that enables a provider to monitor or track the growth of a consumer's social network and, more specifically, the extent of a consumer's social network community that a consumer introduces to the MyMall service.

The transaction services 206 depicted in FIG. 2 include features for supporting the capture and creation of product orders, rules for pricing products, rules for discounting products, and features for integrating a checkout procedure with third party entities such as banks and other credit suppliers and payment services, e.g., services that enable a party to make payment anonymously or pseudo anonymously.

Integration services 208 as shown in FIG. 2 may include various features to facilitate an open platform, high availability network. These features may include, as examples, tools for importing and/or exporting data, tools for transforming data to achieve a degree of uniformity in the format of its data, real-time information features, security/encryption services, communication services, and workflow support features. Consumers 105 are shown in FIG. 5 to provide data and other information to repositories 202, brokering services 204, and social network 160.

In the embodiment depicted in FIG. 2, the modules of MyMall server 110 provide a standardized interface for communicating with the features of providers 120. FIG. 2 depicts, for example, provider 120 sending information indicative of its selling and order fulfillment systems to transaction services 206 while catalog 222 is downloaded or otherwise stored to repositories 202. FIG. 2 further depicts brokering services 204 and analytics services 205 providing information to the internal analytics 224 of provider 120, and store map/planogram 225 providing information to transaction services 206. Loyalty card systems 226 as shown exchanges information with brokering services 204 and integration service 208. Payment systems 228 are shown interacting with transaction services 206 and selling/fulfillment solutions 220.

As alluded to above, some embodiments of disclosed systems and methods may be implemented as or embodied in computer software. In these embodiments, instructions executable by a processor are stored or otherwise embedded in a tangible, computer-readable storage medium. When the instructions are executed by a processor, they cause the processor and its supporting resources to perform one or more methods. The methods that are performed may be represented in flow diagram format. Moreover, although the blocks in the following flow diagrams are connected by arrows suggesting a particular sequential ordering, the ordering shown is merely exemplary, and the order in which the actions corresponding to each block are performed may be different in other implementations.

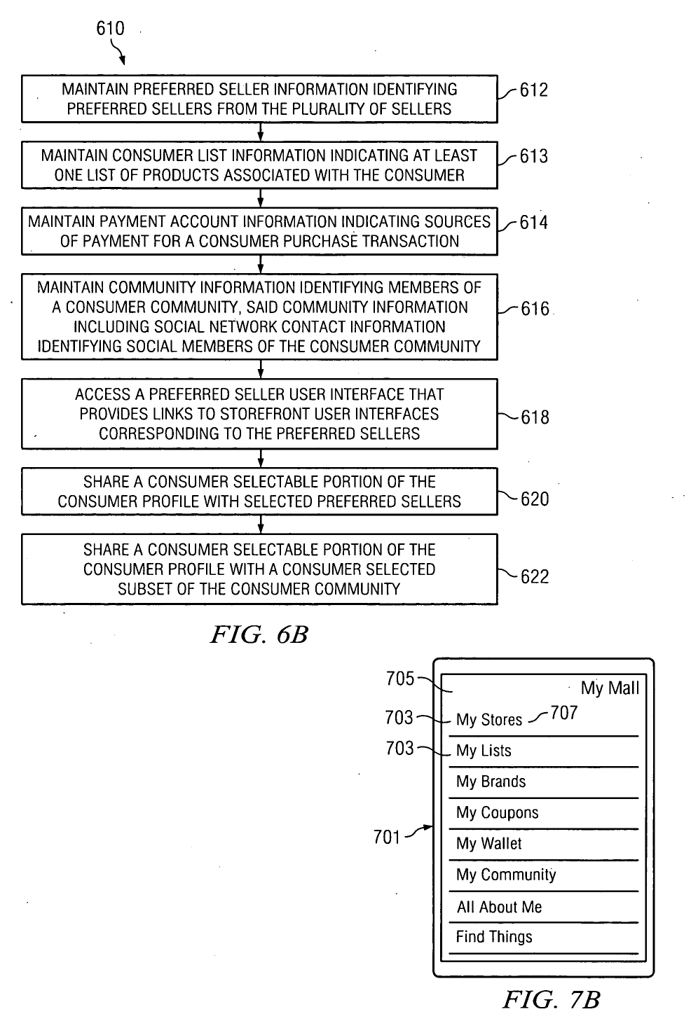

Turning now to FIG. 6A, a flow diagram depicts selected elements of a method 600 for implementing MyMall services as described herein. In the depicted embodiment, method 600 illustrates instructions that represent methods and functions that may be performed by a MyMall server 110 configured to provide the MyMall service. The instructions represented in FIG. 6A include instructions for enabling (602) a provider to establish a provider profile that includes provider profile information indicative of products offered by the provider and enabling (603) a consumer to establish a consumer profile. Method 600 may further include accessing (604) a provider profile database including provider profiles for a plurality of providers and accessing (606) consumer profiles. Method 600 as shown further includes the MyMall server 110 providing (608) a network accessible MyMall application for installation and execution upon a consumer device.

Features that the MyMall application may support are represented by instructions representing a method 610, depicted in FIG. 6B, which may include instructions to maintain the consumer profile including instructions for maintaining (612) preferred seller information identifying preferred providers from a plurality of providers and maintaining (613) consumer list information that indicates at least one list of products associated with the consumer including, as examples, a shopping list and an interest list. The MyMall application depicted in FIG. 6B may further include maintaining (614) payment account information that conveys sources of payment for a consumer purchase transaction, e.g., consumer's credit card and/or bank account information. The MyMall application may further include instructions corresponding to maintaining (616) community information that identifies members of a consumer community, e.g., all or a portion of a client's social network community. The community information may include social network contact information identifying social network members of the consumer's community.

The instructions represented in FIG. 6B further include instructions enabling a consumer to access (618) a preferred seller user interface. The preferred seller user interface may provide links to storefront user interfaces corresponding to the preferred sellers. A storefront user interface enables the consumer to browse and purchase products offered by the seller.

The instructions representing method 610 may further include instructions for sharing (620) a consumer selectable portion of the consumer profile with selected preferred sellers and for sharing (622) a consumer selectable portion of the consumer profile with a consumer selected subset of the consumer community.

Various aspects of the MyMall service and the MyMall client application 415 are now illustrated and presented through a series of screenshots representing the user interfaces that a consumer may be presented with. Most of the depicted screen shots are representative of screen shots suitable for mobile electronic device 104 having a relatively compact display screen, but analogous user interfaces exist for fixed media devices having a relatively large display screen.

Qualitatively, MyMall client application 415 enables consumers to configure a personalized virtual shopping mall. The occupants of this virtual shopping mall may be brick-and-mortar providers, multi-channel providers, Internet-only providers, as well s mobile-only providers. If MyMall client application 415 is installed on multiple devices of a user, e.g., mobile electronic device 104 and fixed access device 103, all of the consumer's devices may be synchronized across all of the available functions.

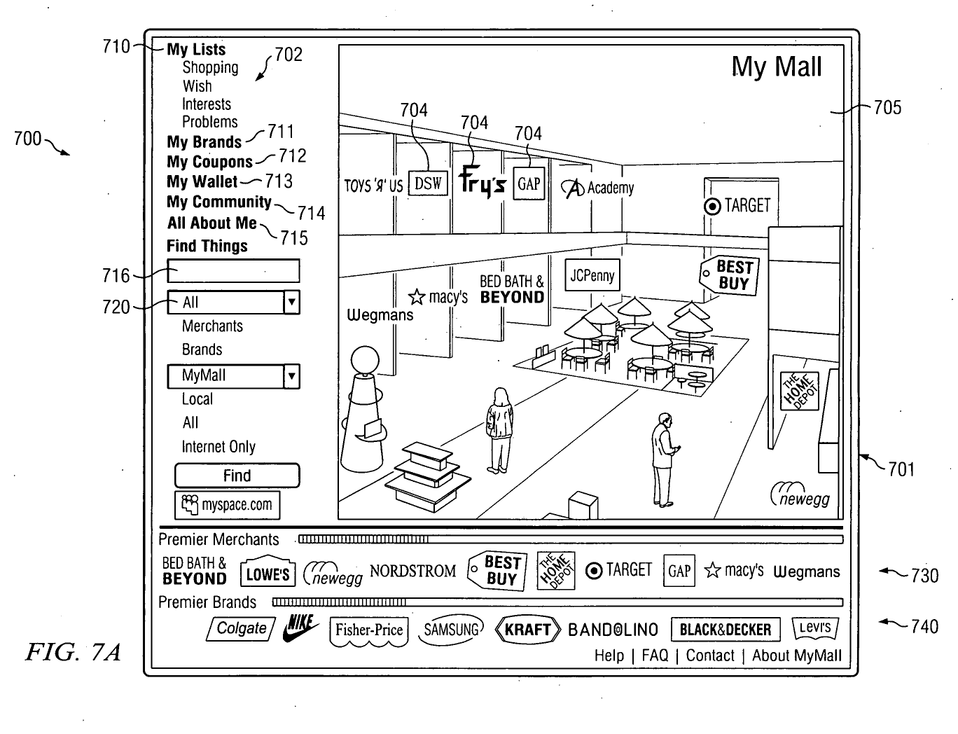

Referring now to FIGS. 7A and 7B, representative consumer interfaces are illustrated for use with a fixed access device (FIG. 7A) and a mobile electronic device (FIG. 7B). The UI 700 depicted in FIG. 7A may be characterized as the “main menu” of MyMall client application 415 for fixed access device 103. As depicted in FIG. 7A, UI 700 includes a feature bar 702 and a display field 705. Feature bar 702 as shown includes hyperlinks 703 for invoking various features of MyMall client application 415. In the depicted embodiment, feature bar 702 includes a MyLists feature 710, a MyBrands feature 711, a MyCoupons feature 712, a MyWallet feature 713, a MyCommunity feature 714, and an AllAboutMe feature 715. Feature bar 702 as depicted further includes a search engine indentified as a FindThings feature 716. In the depicted embodiment, FindThings feature 716 may include selectable filters 720 for focusing or narrowing results generated by FindThings feature 716.

Display field 705 as shown in FIG. 7A is a graphical representation of the consumer's virtual and customized mall. The mall is represented by a set of storefront icons 704 representing the consumer's preferred stores. A consumer may “enter” any of these storefronts by clicking on or otherwise opening the applicable icon 704. The storefront icons shown in FIG. 7A depict a trademark or other recognizable or unique indicia of the corresponding storefront. The embodiment of UI 700 as depicted in FIG. 7A further includes a premier stores bar 730 and a premier brands bar 740. A consumers may maintain their preferred stores and brands by selecting the icons depicted in bars 730 and 740 or by finding a merchant or brand using FindThings feature 716 with the appropriate filter 720. A consumer's presently chosen preferred stores are illustrated in the display field 705.

Referring to FIG. 7B, an exemplary “main menu” UI 701 suitable for a mobile electronic device is depicted. In the depicted embodiment, UI 701 includes a display field 705 that may occupy much or all of the display device of the mobile electronic device. Like UI 700, UI 701 as shown includes a set of icons representing various features of MyMall client application 415 accessible from the main menu. UI 701 includes an icon 703 for a MyStores feature 707 that enables the consumer to view the consumer's currently selected preferred stores, i.e., preferred providers.

Using UIs 700 or 701, a consumer simply chooses icons from a list of Premier Providers, from a list of Premier Brands, or from search results to populate the consumer's mall. Some premier providers may offer pre-staged coupons or other promotions when a consumer elects a provider for inclusion in the consumer's list of MyStores. These coupons, like other coupons, may flow directly into the consumer's MyCoupons feature described below. In some embodiments, these “sign-up” coupons may be available to consumers from sponsoring providers, which may represent a subset of all available providers. In this embodiment, a consumer may include non-sponsoring providers or participating providers in the consumer's mall, but pre-staged coupons and other offers may be available only from Premier Merchants such as those listed in premier store bar 730. Consumers may select their preferred brands in much the same way using feature 711 and analogous special offers may be available from the Premier Brands.

In some embodiments of the MyMall client application 415 depicted in FIG. 4, all of the consumer's payment information, personal data, preferences, and data may be imported from a social network. MyMall client application 415 may support a variety of lists to identify near-term shopping requirements, longer-term wishes and purchase criteria, personal interests, or even problems to which the consumer needs a solution. These lists may be shared with MyStore stores and/or MyBrand brands, possibly in exchange for promotional incentives from the store or brand.

When a consumer creates a mall, MyMall client application 415 enables the consumer to share lists, coupons, promotions, preferences, or even the entire mall, with friends and family, other users, or through a existing social network site (e.g., sharing a consumer's interest list on Facebook).

Using MyMall client application 415, a consumer can search for products, view specifications, read reviews from social network peers and/or industry experts, and get a price quote. MyMall client application 415 enables consumers to limit product searches to their personal malls, a subset of stores or brands residing in their personal mall, or if they prefer, search the Internet more widely.

In some embodiments, MyMall client application 415 permits consumers to use a single tap of the device display screen to initiate purchase transactions or add items to their lists (with options for purchase category and merchant).

In some embodiments, the lists supported by MyMall client application 415 may indicate products consumers need to buy, where to buy them, and whether special criteria apply to a purchase decision. The MyMall client application 415 may include history information enabling a consumer to keep track of previous purchases, thereby simplifying repeat purchases and permitting scheduled purchases of products that may require regular replenishment, e.g., a standing order to purchase light bulbs every quarter.

The lists supported by MyMall client application 415 may be populated in various ways, including, as examples, by manual entry of an item name, SKU, UPC, or GTIN, by scanning a bar code on a package, by scanning in-store items, displays, kiosks, or digital signs, by choosing from product search results, by importing an item from a social network, by linking to a coupon or promotion, or by responding to a TrendSpotter alert. In some embodiments, MyMall client application 415 may add an item to a list automatically when the consumer's user device is in proximity to a device that needs replenishing.

MyMall client application 415 may enable consumers to share lists with friends to trigger the targeting, by providers, and sharing of coupons and promotions and to share lists with other family members who help with shopping, e.g., a husband's shopping list may be supplemented when a wife adds an item to the list. Lists may be shared with providers in a consumer's mall to personalize the consumer's shopping experience and tailor special offers.

Some embodiments support a TrendSpotter alert feature that informs a consumer regarding popular products that others in the consumer's social network community have been buying and inform the consumer if a preferred store of the consumer has the item on sale. In some embodiments, a Hot-or-Not feature of MyMall client application 415 enables consumers to easily share experiences within a consumer's defined community. A consumer could identify the item by any of the available product search mechanisms or list maintenance mechanisms, add any comments, and rate the product by tagging it “Hot” or “Not.” Hot-or-Not information may be automatically shared within the consumer's community, e.g., friends, stores, and brands, using list/preference sharing options provided by MyMall client application 415.

MyMall client application 415 also facilitates actual on-line purchasing of a product by enabling the consumer to tap the store name to enter the desired storefront. The store selected may greet the consumer with coupons, unadvertised special offers, or the like. A consumer may accept such a coupon by tapping to claim the offer, after which MyMall client application 415 adds the coupon to the consumer's electronic wallet and the item to the consumer's shopping list. If the consumer has shared lists and preferences with this merchant, the consumer may further receive customized or tailored offers.

When a consumer enters a store front, MyMall client application 415 may automatically retrieve and display items on a consumer's list that are available from the store, with options to get more information, buy items from the list, or continue shopping.

If the consumer enters a brick-and-mortar store, MyMall client application 415 and mobile electronic device 104 may detect the location and determine the identity of the store. The store may then provide guided shopping information such as maps that help the consumer find items within the store by, for example, pointing the consumer to a specific item on a list or giving the consumer a map to find directions to the next item the consumer needs. Providers can leverage this consumer location information with planogram information to generate in-aisle specials delivered directly to a consumer's mobile electronic device.

Checking out and making payment with MyMall client application 415 is simple. The consumer's payment options are stored securely (encrypted) in a database accessible to the mobile electronic device and can be accessed at time of payment. In some implementations, credit card, bank account, or other financial information is not stored on the consumer's user device, thereby reducing personal risk if the device is lost or stolen. Electronic coupons may be applied to payment automatically before the purchase total is calculated. After selecting a payment method, MyMall client application 415 makes payment securely either on-line or at the point-of-sale device in the store. The merchant may deliver an electronic receipt directly to a MyMall client application repository (not depicted).

MyMall client application 415 may further enable the consumer to track shipments and monitor service appointments regardless of location or user device.

In some embodiments, MyMall client application 415 may highlight stores and brands that are new to the plurality of MyMall enlisted stores. The consumer could configure how long a store or brand would remain in a “What's New” resource before it would expire. New stores and brands could be deleted from the What's New list by either adding them to a personal list or removing them entirely.

Another feature of some embodiments of MyMall client application 415 enables a consumer to nominate or request the addition of a store or brand that is currently not enlisted. Moreover, the MyMall client application, in conjunction with MyMall server 110, may solicit the user's community to support the request. This feature enables consumers to add stores/brands to their list of stores/brands even though the store or brand isn't a participating member of the plurality, thus giving MyMall server 110 a means to boot strap participation of stores and brands by collecting information that could be used to promote the participation to the store or brand.

As suggested above, some embodiments support two or more types of participating providers, including sponsoring providers and participating providers. Sponsoring providers may represent providers that are actively engaged and/or pay for participation and receive details on consumer activity and offer coupons and related services. Participating providers are the remaining stores that are in the plurality of enlisted providers. The MyMall service and MyMall server 110 may gather information on consumer activity and then use the information to encourage the store or brand to become a sponsor.

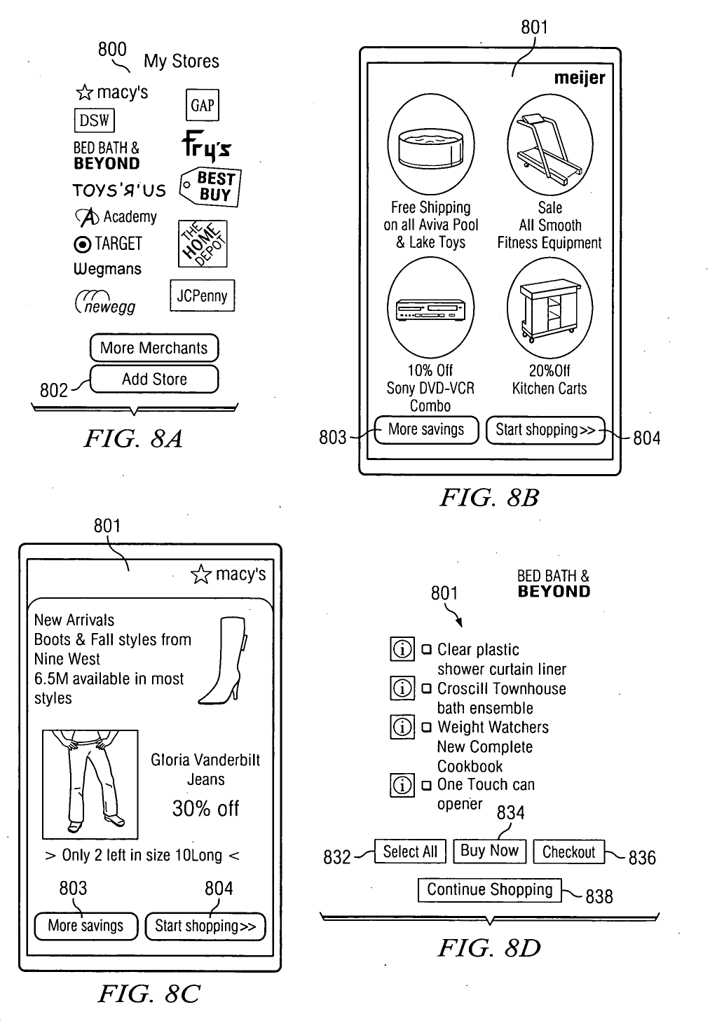

Returning now to the drawings, FIG. 8A illustrates a MyStores UI 800, invoked when a consumer taps the MyStores feature from the main menu, and exemplary electronic storefront UIs 801 for three different stores in FIG. 8B, FIG. 8C, and FIG. 8D. MyStores UI 800 as shown includes an AddStore button element 802 enabling consumers to easily add stores to their preferred lists of stores. Storefront UIs 801 are displayed when a user taps on the respective icon in the MyStores UI 800. As depicted in FIG. 8B a storefront UI 801 may display items that are on sale, on a list of the consumer, or popular in the consumer's demographic segment and/or community or social network. As depicted in FIG. 8C, storefront UI 801 may include a coupon generated by the store in response to the consumer's selection of the storefront. The storefront UI 801 depicted in FIG. 8D illustrates an example in which a consumer enters the virtual storefront of a store that is indicated on the consumers shopping list, e.g., the shopping list includes one or more items that the user assigned to this store. In this case, storefront UI 801 includes elements for selecting all of the items (832), purchasing all of the items now (834), checking out (836), and continuing to shop at the store (838). Storefronts 801 may present the user with a uniform experience across merchants by including certain storefront elements in standardized locations. In FIGS. 8B and 8C, for example, the Start Shopping element 804 and More Savings element 803 are located in the same place on each UI 801.

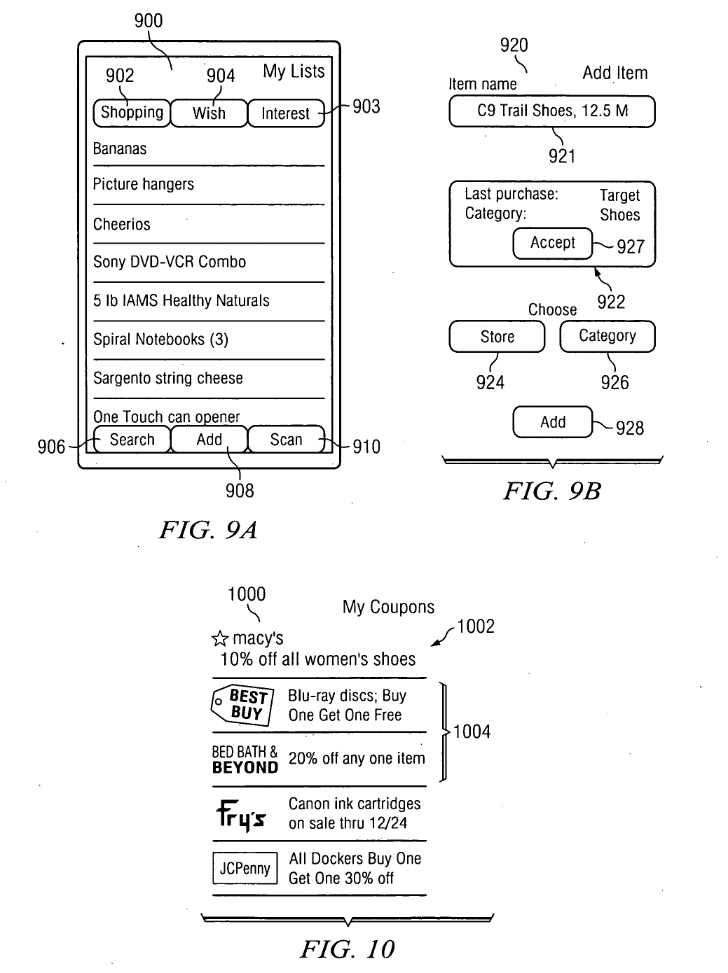

FIG. 9A depicts a list UI 900 that includes tabs for a shopping list 902, a wish list 904, and an interest list 903. These lists may reflect varying degrees of immediacy with the shopping list 902 representing items presently needed, the wish list 904 containing items that may be costlier or of less immediate importance, and so forth. In other embodiments, different sets of lists may be used. List UI 900 as shown in FIG. 9A includes elements for searching a list (906), adding an item to a list (908), and scanning an item into a list (910). FIG. 9B depicts an AddItem UI 920 that indicates a name for the item (921), a purchase history (922), and elements for assigning an item to a particular store (924) or category (926). An item may be added to a list using add element 928 or using accept element 927 to use the information from the most recent historical purchase.

FIG. 10 depicts a MyCoupons UI 1000 depicting a list 1002 of current electronic coupons 1004. Coupons 1004 may be added to MyCoupons list 1002 automatically by a provider when, as examples, the consumer visits the provider's storefront or the consumer shares list or preference information with the provider. The MyMall client application 415 may automatically check for an applicable coupon 1004 when a consumer views or purchases a product and apply the coupon as part of a payment transaction.

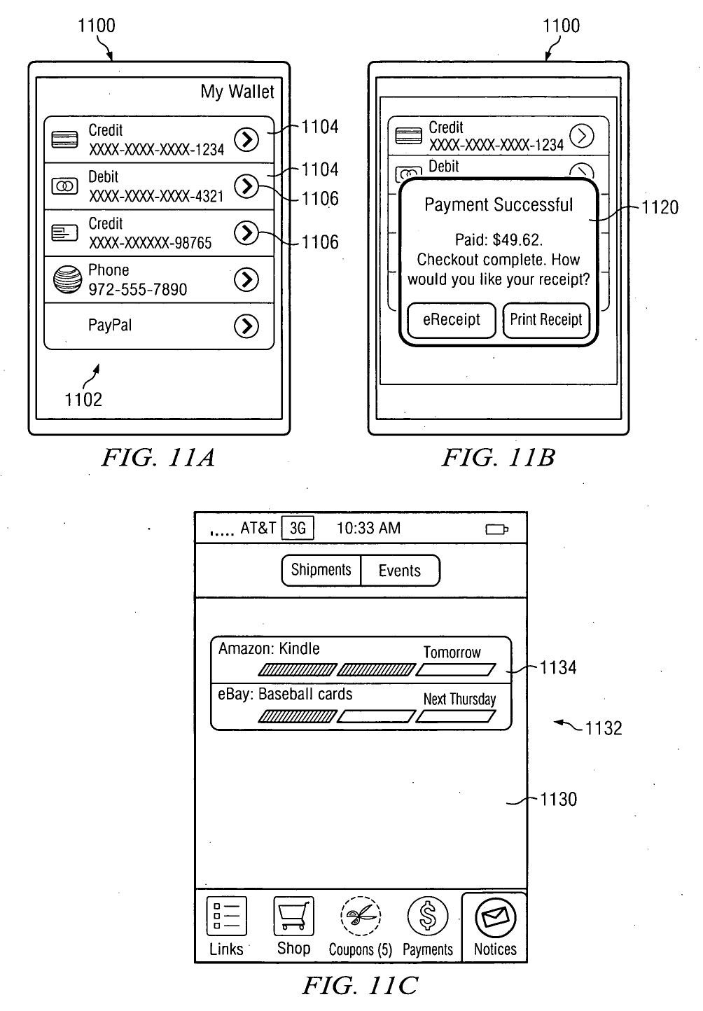

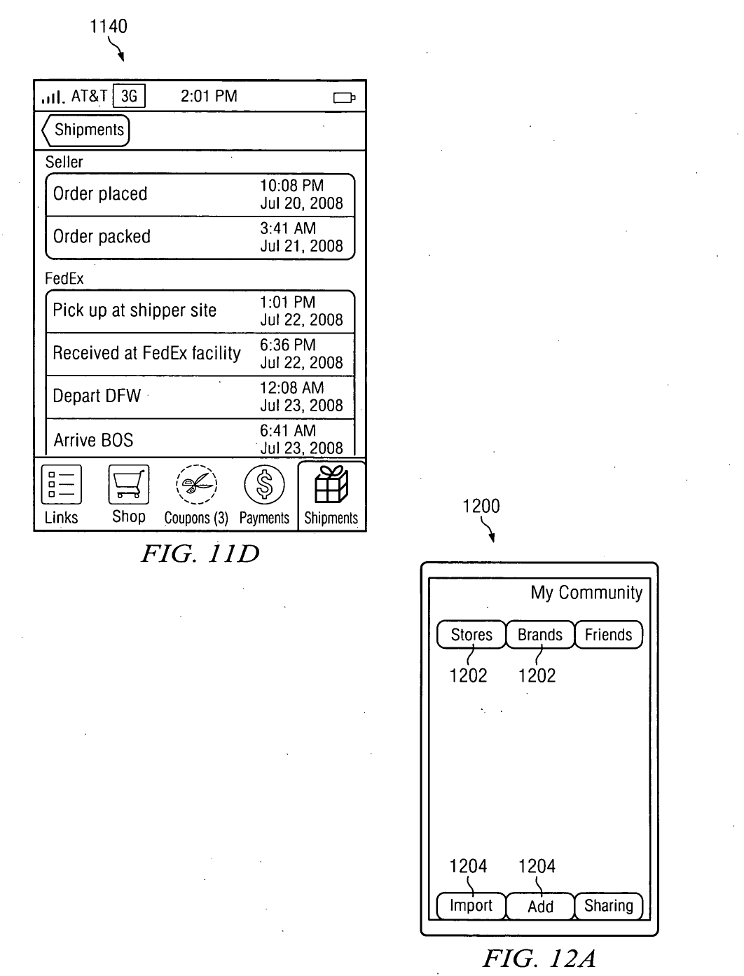

FIG. 11A depicts a MyWallet UI 1100 that depicts a list 1102 of accounts 1104 available for a payment transaction. Accounts 1104 may include credit card and debit card accounts, bank accounts, and anonymous payment accounts, e.g., a PayPal account, as well as other types of accounts available for payment. In the depicted embodiment, the accounts 1104 include a selectable button element 1106 that reveals additional account information when selected. This information could include, for example, current balance information, payment due and due date information, statement closing date information, and the like. FIG. 11B depicts an exemplary payment confirmation UI 1120 that pops up or otherwise appears when a transaction is approved. In the depicted embodiment, payment confirmation UI 1120 prompts the consumer to indicate whether an electronic receipt or hard copy receipt is preferred.

FIG. 11C depicts an exemplary shipments/events UI 1130 that includes a list 1132 of previous purchases with a bar graphic that indicates the age and expected delivery date of the item. Any of the individual items 1134 in the list may be selected to bring up an order detail UI 1140 depicted in FIG. 11D. The order detail UI 1140 indicates a date the order was placed, a date the order was packed or otherwise processed, and tracking status information for the corresponding shipment.

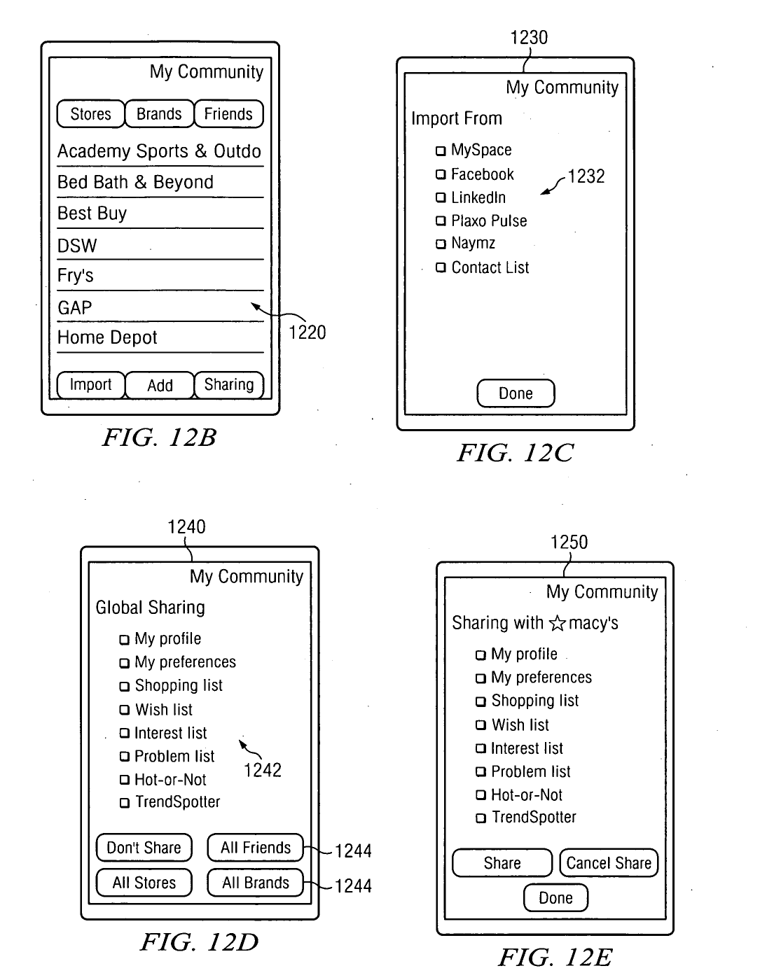

FIG. 12A depicts an exemplary MyCommunity UI 1200 for creating a consumer-specific community of entities and individuals with whom the consumer may wish to share information. In the embodiment depicted in FIG. 12A, MyCommunity UI 1200 includes tabs 1202 for various segments of a consumer's community including a stores community, which includes all of the stores that a consumer has added to his or her community, a brands community, and a friends community. MyCommunity UI 1200 also includes button elements 1204 for importing friends, stores, and brands, for adding friends, stores, and brands individually, and for displaying sharing options associated with some or all of the members of a consumer's community. FIG. 12B depicts an exemplary list 1220 of stores in a consumer's community. Selecting any of the stores in the list 1220 may bring the consumer directly to the corresponding electronic storefront. FIG. 12C depicts an exemplary community import UI 1230 that appears when the consumer taps the Import tab in MyCommunity UI 1200. The community import UI 1230 includes a list 1232 of social network sites, personal contact lists, and other sources of contacts that consumers may wish to include in their MyCommunity space. Using community import UI 1230 enables consumers to create communities with a few taps of a display screen by leveraging existing sets of contact lists and information. FIG. 12D depicts an exemplary global sharing UI 1240 that includes a list 1242 of selectable consumer profile items and button elements 1244 for indicating sharing options for the selected elements. For example, a consumer may select the shopping list element from list 1242 and the All Friends button element 1244 to share the consumer's shopping list with his or her friends. In the embodiment depicted in FIG. 12D, the list 1242 of consumer profile elements that may be shared include the consumer's entire profile, the consumer's preferences, shopping list, wish list, interest list, problem list, Hot-or-Not messages, and TrendSpotter messages. FIG. 12E depicts a sharing UI 1250 for sharing profile elements with a specific member of the consumer's community. In FIG. 12E, for example, UI 1250 is used to indicate sharing options for a specific store. Sharing UI 1250 may appear when a consumer taps a specific store, brand, or friend from a list 1220 in UI 1200.

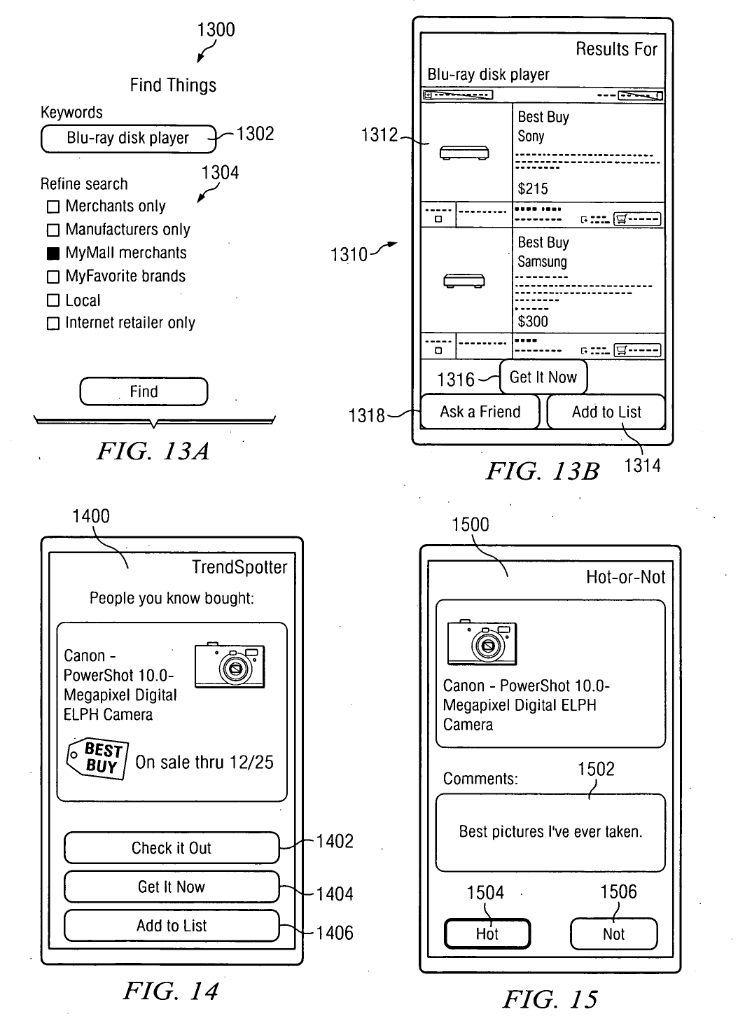

FIG. 13A depicts a FindThings UI 1300 that provides a product search function to the consumer. The depicted embodiment of FindThings UI 1300 includes a keyword text box 1302 and refinement elements 1304 that enable the consumer to define the scope of the desired search. A consumer might, for example, limit a search to only those stores that are in the consumer's MyStores list, limit the search to stores that are local, limit the search by brand, and so forth. In the depicted embodiment of FindThings UI 1300, searches can be restricted based on preferred providers, a user identified list of product brands, a geographic criteria, and an online status of providers in the search results An example of a product search result UI 1310 is depicted in FIG. 13B. In the depicted example, product search result UI 1310 includes a list 1312 of some or all results that match a search. UI 1310 as shown includes button elements that enables consumers to select an item from list 1312 and add the item to their shopping lists (1314), purchase the item immediately (1316), or obtain a product evaluation opinion from someone in the consumer's community by tapping the Ask a Friend button element 1318.

FIG. 14 depicts an exemplary TrendSpotter UI 1400. TrendSpotter UI 1400 may appear as a pop-up window delivered to a consumer's user device identifying a product that matches a criteria that may be defined by the consumer, the store, the brand, the MyMall service, or a combination thereof. If a product is determined to meet defined TrendSpotter criteria, a TrendSpotter UI 1400 is delivered to the consumer's user device. UI 1400 may include a depiction and/or description of the product, a button element 1402 to obtain additional information, a button element 1404 to purchase the product immediately, and a button element 1406 to add the product to the consumer's shopping list or other list.

FIG. 15 depicts an exemplary Hot-or-Not UI 1500 that a consumer may use to rate a product. In the depicted embodiment, a product is rated as being either good (Hot) or not (Not). The Hot-or-Not UI 1500 as shown includes a depiction or description of the product, a comment box 1502 permitting the consumer to add text comments to the rating, and buttons 1504 and 1506 enabling the consumer to rate the product Hot or Not respectively.

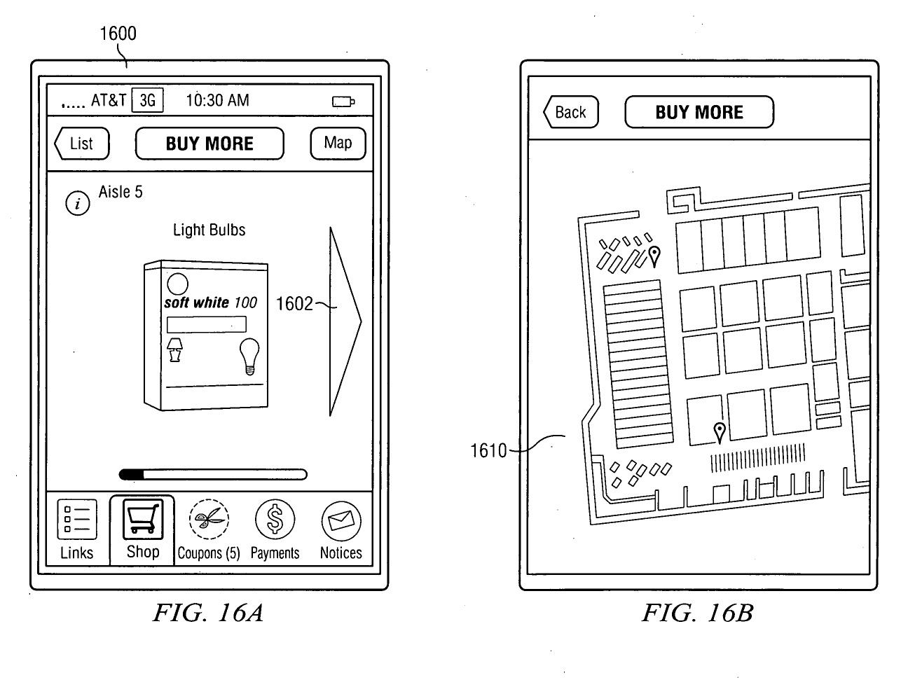

FIG. 16A and FIG. 16B depict UIs that MyMall client application 415 may generate when a consumer is shopping within a brick and mortar store. In some embodiments, the consumer's user device, presumably a mobile electronic device 104, is aware when a user enters a brick and mortar store. This awareness may be the result of GPS functionality, possibly in combination with an exchange of messages that may occur when the consumer enters the store. Stores may, for example, transmit a “welcome” message at all store entrances and MyMall client application 415 may be configured to monitor for and detect such messages. When mobile electronic device 104 detects a welcome message or otherwise determines that the consumer has entered a store, MyMall client application 415 may acquire or otherwise access local store information from MyMall server 110 or from a server within the store itself. The local store information may include hours of operation information, sales event information, and a graphical representation of a store map such as the store map 1610 depicted in FIG. 16B. When the user enters the store, the MyMall client application may retrieve items from the consumer's shopping list and compare the items with items that the store currently has in its inventory. If, for example, the consumer has light bulbs in the shopping list and the store has light bulb inventory, MyMall client application 415 may depict the applicable product with a product available UI 1600, an embodiment of which is shown in FIG. 16A. In the depicted embodiment, product available UI 1600 includes a depiction of the product and a textual description of the location of the product within the store, e.g., “Aisle 5.” In addition, the depicted embodiment of product available UI 1600 includes an arrow element 1602 that “points” the consumer to the side of the applicable aisle on which the product is located. In some embodiments, arrow element 1602, when tapped, may also retrieve and display the store map with an indication of the location of the product and, in some embodiments, the current location of the consumer. While the consumer is inside the store, the consumer may also obtain the location information of a product that is not on a consumer's list by simply identifying the product using, as examples, the search tool, clicking on a coupon, TrendSpotter alert, or Hot or Not alert, by scanning an item, and so forth. Once a product is identified, MyMall client application 415 may generate a product available UI 1600 corresponding to the identified product in the same way that MyMall client application 415 generates product available UI 1600 for products that are on a consumer's list.

Following is a narrative description of a consumer's use of the MyMall service to illustrate aspects of the UIs and other features discussed above. From Consumer's desktop computer at home, Consumer browses to a MyMall website hosted by MyMall server 110 and clicks on a “Get Started Now” element. After Consumer creates Consumer's consumer account including some personal credentials, the MyMall server application may provide Consumer with one or more start-up tips after which Consumer is ready to create a personal environment.

Consumer may be accessing the MyMall service using a fixed media device 103 or a mobile electronic device 104. Although the display screen on the mobile electronic device 104 is smaller, it can be used to access all of the things available via the Consumer's desktop.

Depending upon whether Consumer is using a fixed access device or a mobile electronic device, Consumer populates Consumer's mall with the stores Consumer likes to visit using, in the case of a fixed access device, main menu UI 700, display field 705, and premier stores bar 730 or, in the case of a mobile electronic device, main menu 701, MyStores feature 707, and MyStores UI 800. Consumer may also add Consumer's favorite brands using a MyBrands UI (not depicted).

Consumer may then return to the main menu and tap “MyCoupons.” In some embodiments, Consumer's coupon UI is populated with coupons from the stores Consumer added to Consumer's MyStores list.

Consumer again returns to the main menu and taps “MyCommunity.” Consumer discovers that Consumer's business community (stores and brands) is already populated from the selections Consumer made when Consumer created Consumer's mall. Consumer then needs only to add Consumer's social community of friends to Consumer's MyCommunity space. Consumer taps “Friends” to activate Consumer's friends list and decides to import from Consumer's favorite social networks. Tapping “Import” allows Consumers to choose the sources from which to import Consumer's friends.

After importing friends into Consumer's MyCommunity, Consumer returns to Consumer's MyCommunity “Stores” list (FIG. 12B) and taps on “Sharing” to access the sharing features. Consumer elects to share “Hot-or-Not” information with all Consumer's friends. Consumer sees that Consumer could decide to share Consumer's shopping list with all Consumer's stores, but elects not to. Consumer returns to Consumer's community and selects a specific store just by tapping on it. Consumer elects to share Consumer's preferences, Consumer's shopping list, and Consumer's wish list with Macy's.

Consumer then accesses TrendSpotter with Best Buy.

Consumer then returns to the main screen and tap “MyLists” to create Consumer's shopping and wish lists. Consumer adds items Consumer needs from the store, e.g., groceries, and other items Consumer has been intending to buy, e.g., a Blu-ray disk player. Consumer then returns to the main screen and taps “Find Things” to research Blu-ray disk player. Consumer elects to confine a product search to the stores in Consumer's mall, so Consumer limits the search to Consumer's “MyMall merchants”.

Scrolling through the results, Consumer finds an acceptable player and taps on it to add it to Consumer's shopping list. Consumer will be able to choose where Consumer wants to buy it this information may be used to facilitate automated filtering and sorting when Consumer is actually shopping. Consumer may ask a friend for advice just by tapping the button and selecting the friend in Consumer's community who is an expert on these players.

At a later date, Consumer taps “MyStores” and enters the virtual storefront for Bed Bath and Beyond by tapping it. The items on Consumer's shopping list that she planned to purchase here are displayed. Consumer can obtain product information if Consumer needs to know more about an item, buy selectively from Consumer's list, buy all the items on the list, or continue shopping in the on-line store before eventually going to checkout where Consumer can choose a payment method from what Consumer had previously stored securely in the MyMall server platform.

Any coupons of Consumer that apply to this purchase will be automatically redeemed before Consumer's “Amount Due” is calculated.

Consumer next receives a TrendSpotter alert indicated by an audible (ringing) or motion (vibrating) alarm for a digital camera informing Consumer that the camera was recently purchased by someone in Consumer's community who shares this type of information. Consumer adds the camera to Consumer's list for reviewing and possible purchasing at a later time. Consumer then checks the status of Consumer's Bed Bath and Beyond purchase.

Consumer then stops at a brick and mortar Macy's and, just as Consumer is walking in the door, Consumer's phone signals that Consumer has a message. Because Consumer shares some of her profile information with Macy's, Macy's is able to present Consumer with a coupon, possibly for an item, brand, and/or size that is indicated in Consumer's profile. If new jeans are on Consumer's shopping list (and all Consumer's brands and sizes shared), Macy's may be able to inform Consumer that they are having a sale on jeans and still have Consumer's size in stock.

Consumer then visits the grocery store, and invokes a “Guided Shopping” feature. Using the item locator and store map that is presented to Consumer, Consumer goes through the shopping list efficiently. Back at home, Consumer tries a few sample pictures with Consumer's new camera and decides the camera is great. Consumer brings up Hot-or-Not and rates Consumer's new camera. Since Consumer has already shared this feature with all of Consumer's friends, Consumer's comments and Consumer's “Hot” rating will automatically go out to them.

To the maximum extent allowed by law, the scope of the present disclosure is to be determined by the broadest permissible interpretation of the following claims and their equivalents, and shall not be restricted or limited to the specific embodiments described in the foregoing detailed description.

What is claimed is:

1. A consumer-oriented commerce facilitation (COCF) server, the COCF server including a processor having access to a tangible storage medium including embedded instructions, executable by the processor, for providing a COCF service, the instructions comprising instructions for:
enabling a provider to establish a provider profile comprising provider profile information indicative of products offered by the provider;
enabling a consumer to establish a consumer profile;
accessing a provider profile database including provider profiles for a plurality of providers;
accessing the consumer profile; and
providing a network accessible COCF client application, wherein the COCF client application enables the consumer to:
maintain the consumer profile, including maintaining:
preferred provider information identifying preferred providers selected from the plurality of COCF enlisted providers;
consumer list information indicating at least one list of products associated with the consumer;
payment account information indicating sources of payment for a consumer purchase transaction; and
community information identifying members of a consumer community, said community information including social network contact information identifying social members of the consumer community;
access a preferred provider user interface, wherein the preferred provider user interface provides links to storefront user interfaces corresponding to the preferred providers, wherein a storefront user interface enables the consumer to browse and purchase products offered by the provider;
share a consumer selectable portion of the consumer profile with selected preferred providers; and
share a consumer selectable portion of the consumer profile with a consumer selected subset of the consumer community.

2. The server of claim 1, wherein the COCF client application enables the consumer to:
access a payment user interface graphically displaying accounts included in the payment account information; and
select, from the displayed accounts, an account for payment during a purchase transaction.

3. The server of claim 2, wherein the consumer profile includes coupon information indicative of a set of coupons and further wherein the payment user interface automatically applies any applicable coupon during a purchase transaction.

4. The server of claim 1, wherein the consumer profile further includes preferred brand information identifying preferred product brands selected by the consumer from a list of available brands, wherein the COCF client application enables the consumer to share the preferred brand information with members of the consumer community, and wherein said sharing of the preferred brand information triggers targeting of coupons or promotions associated with the preferred brands.

5. The server of claim 1, wherein the COCF client application further enables the consumer to access a COCF search interface operable to receive search input indicative of a desired product and further operable to display search results indicative of at least one of: providers of the desired product and brands of the desired product, and wherein the COCF search interface is further operable to receive user input restricting the search results based on a consumer-specified search restriction criteria.

6. The server of claim 5, wherein the search restriction criteria is selected from the group consisting of the preferred providers, a user-specified list of product brands, a geographic criteria, and an online status of providers in the search results.

7. The server of claim 5, wherein items in the search results are selectable by the consumer and wherein the search interface is configured to enable the consumer to process a selected item from the search results, wherein processing a selected item comprises at least one of: purchasing the selected item, querying a member of the consumer community regarding the selected item, and adding the selected item to the consumer list information.

8. The server of claim 1, wherein the consumer list information is indicative of a plurality of lists of products, the plurality of lists including at least one of: a shopping list indicating products currently needed by the consumer, a wish list indicating other products desired by the consumer, and an interest list indicating products or services of interest to the consumer and further wherein the COCF client application responds to a consumer input selecting one of the plurality of lists by displaying the selected list.

9. The server of claim 8, wherein the COCF client application enables the consumer to add a product to one of the plurality of lists by a method selected from, manual entry of information identifying the product to add, scanning with a consumer device a bar code associated with the product to add, selecting the product to add from search results generated by a search engine, importing a product to add from profile information shared by a member of the consumer community, processing a product assessment received from a member of the consumer community, or processing a coupon or promotion.

10. The server of claim 1, wherein the COCF client application is operable to provide at least one of coupons and promotions to the consumer responsive to determining portions of the consumer profile being shared with members of the consumer community.

11. The server of claim 1, wherein the COCF client application is configured to detect a proximity of a consumer device to a store of a provider, said consumer device having a computer readable storage medium in which the COCF client application is stored.

12. The server of claim 11, wherein the COCF client application is operable: to send a coupon to the consumer device responsive to said detecting; to identify products in the list of products offered in the store; to access store plan-o-gram information and display a store map identifying a location within the store of the identified products; to provide an instantaneous promotion based on a current location of the consumer within the store and products in proximity to the current location; and to provide a customized promotion to the consumer responsive to determining that the consumer shares a portion of the consumer profile with the provider.

13. The server of claim 12, wherein a product associated with the coupon is determined based in part on information in the consumer profile.

14. The server of claim 1, wherein the COCF service is operable to broadcast within portions of the consumer community, trend alerts for specific products, wherein the trend alerts are indicative of purchases of the product by members of the consumer community.

15. The server of claim 14, wherein the COCF client application is configured to display trend alerts from members of the consumer community addressed to the consumer and wherein the displayed trend alerts include selectable options for at least one of: obtaining additional information regarding the specific product, purchasing the specific product, and adding the specific product to the consumer list information.

16. The server of claim 1, wherein the COCF service is operable to broadcast, within the consumer community, product assessments generated by consumer community members.

17. The server of claim 16, wherein the COCF client application is configured to process an incoming product assessment by: purchasing the assessed product, adding the assessed product to the list, and initiating a search for the assessed product.

18. The server of claim 1, wherein the COCF client application further enables the consumer to nominate a store for addition to the plurality of COCF enlisted stores and to solicit the consumer's community to support the nomination.

19. The server of claim 1, wherein the COCF client application is configured to display indications of at least one of a new store added to the plurality of COCF enlisted providers and a new brand added to a list of available brands.

20. The server of claim 1, wherein the COCF server is configured to target provider coupons and promotions based, in part, on sharing of preferred provider lists among consumers, and wherein the sharing of the preferred store information triggers targeting of coupons associated with the preferred store to either one or both sharing initiator and recipient.
